(19) United States
(12) Patent Application Publication
(10) Pub. No.: US 2026/0149853 A1
(43) Pub. Date: May 28, 2026

(54) AUTOMATED TIMED TEXT WORKFLOW SYSTEM INTEGRATING MACHINE TRANSLATION, AI-DRIVEN TOOLS, AND HUMAN REVIEW FOR HIGH-VOLUME MEDIA PROCESSING

(71) Applicant: Paulette Pantoja, Santa Clarita, CA (US)

(72) Inventor: Paulette Pantoja, Santa Clarita, CA (US)

(21) Appl. No.: 19/400,276

(22) Filed: Nov. 25, 2025

Related U.S. Application Data
(60) Provisional application No. 63/724,580, filed on Nov. 25, 2024.

(51) Int. Cl. H04N 21/488; G06F 40/58; H04N 21/234; H04N 21/242; H04N 21/25

(52) U.S. Cl. CPC H04N 21/4884; G06F 40/58; H04N 21/23418; H04N 21/242; H04N 21/251

(57) ABSTRACT

A scalable, automated timed text workflow system designed to optimize the generation and refinement of time-synchronized textual content for video is disclosed. Integrated Machine Translation (MT) models and advanced AI-driven tools such as Computer Vision, Generative AI, and Traditional AI automatically generate and refine timed text, including subtitles, closed captions (CC), and SDH (Subtitles for the Deaf and Hard of Hearing). Human review is coordinated through a workflow orchestration system when needed, offering flexibility and scalability for handling high-volume media processing across various platforms and formats.

### PRIORITY CLAIM

This application claims priority to provisional application Ser. No. 63/724,580 filed on Nov. 25, 2024.

### FIELD OF THE INVENTION

This disclosure relates to automated systems for generating, refining, and synchronizing timed text for video content, encompassing subtitles, closed captions (CC), and SDH (Subtitles for the Deaf and Hard of Hearing). The system integrates machine translation, artificial intelligence, and human review into a centralized and scalable workflow, ensuring high-quality timed text for various media platforms.

### BACKGROUND OF THE INVENTION

Timed text, including subtitles, closed captions (CC), and SDH (Subtitles for the Deaf and Hard of Hearing), plays a crucial role in making video content accessible to a global and diverse audience. However, generating accurate, synchronized, and contextually appropriate timed text remains a challenge, particularly when handling large volumes of media.

Existing solutions for timed text generation often rely on manual labor or incomplete automation, making it difficult to ensure accuracy and scalability. While machine translation and AI tools have been developed, they typically lack the context, fluency, and cultural adaptation required for high-quality outputs, and still require significant human oversight. Thus, there is a need for a system that automates much of the timed text process while providing the flexibility for human intervention when needed.

### SUMMARY AND OBJECTS OF THE INVENTION

The invention presents an automated workflow system for generating and refining timed text (subtitles, closed captions, and SDH) for video content. The system integrates Machine Translation (MT) models and advanced AI tools, including Computer Vision and Generative AI, to ensure accurate and fluent timed text. A workflow orchestration system manages the entire process, determining when human review is necessary based on predefined rules or client requirements. The system offers scalability for high-volume media processing through its cloud-based architecture and supports delivery to various media platforms.

### BRIEF DESCRIPTION OF THE DRAWINGS

The present invention is illustrated by way of example and not limitation in the figures of the accompanying drawings in which like references indicate similar elements, and in which:

FIG. 1 is an image showing the work flow path according to an embodiment of the present disclosure.

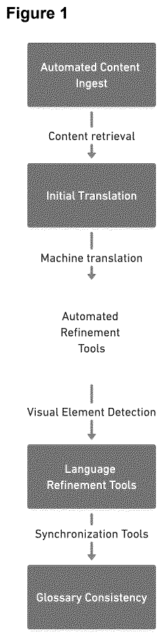

FIG. 2 is an image showing another workflow path according to an embodiment of the present disclosure.

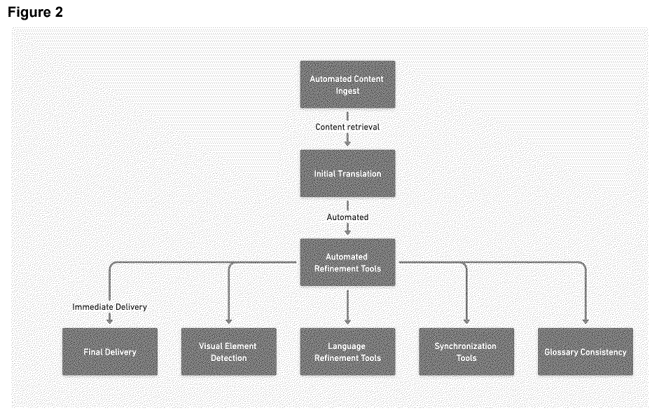

### DESCRIPTION OF THE PREFERRED EMBODIMENTS

In the following description, for purposes of explanation, numerous specific details are set forth in order to provide an understanding of the present invention. It will be evident, however, to one skilled in the art that the present invention may be practiced without certain specific details. In other instances, well-known structures and devices are shown in block diagram form to facilitate explanation. The description of preferred embodiments is not intended to limit the scope of the claims appended hereto. In addition, future and present alternatives and modifications to the preferred embodiments described below are contemplated. Any alternatives or modifications which make insubstantial changes in function, in purpose, in structure, or in result are intended to be covered by the claims of this patent.

### 1. Automated Content Ingest

The system begins by automatically ingesting media content through a watch folder API or similar automated retrieval system. This enables continuous processing without manual intervention, supporting large-scale media workflows.

### 2. Initial Translation via Machine Translation (MT) Models

Once the media content is ingested, MT models perform the initial translation of timed text, including subtitles, CC, or SDH, from the source language to the target language. This generates the first draft of the timed text using automated methods.

### 3. AI-Driven Refinement

The system applies multiple AI tools to refine and enhance the timed text:
Computer Vision: Detects and integrates on-screen text and other visual elements into the timed text.
Generative AI: Improves fluency, tone, and naturalness, ensuring contextually appropriate timed text.
Traditional AI: Handles synchronization, ensuring the timed text matches the audio and video accurately.
Key & Phrase Glossary: Ensures consistency across specific terms and phrases in the timed text.

### 4. Optional Human Review via Workflow Orchestration

The system uses a workflow orchestration tool to determine whether human editors are required to review the timed text, based on predefined project rules or client requirements. Human review ensures the cultural and contextual accuracy of the timed text, including subtitles, CC, and SDH.

### 5. Final Delivery

After either AI-driven refinement or human review, the final timed text is delivered to the specified endpoint, ensuring seamless integration with media platforms.

### Advantages

Scalability: Cloud architecture enables the system to handle high-volume timed text generation.
Flexible Automation with Human Oversight: Offers the ability to integrate human review when needed, without sacrificing automation efficiency.
End-to-End Workflow Management: Supports the entire process from content ingest to

final delivery, with minimal manual intervention.

What is claimed is:

1. A method for automating timed text workflows, comprising:
automatically ingesting media content through a watch folder API or similar retrieval system;
applying machine translation models to generate initial timed text from the source language to the target language;
refining the timed text using automated tools, including:
computer vision to detect on-screen text and visual elements;
generative AI tools for tone and fluency adjustments;
traditional AI tools for timing and synchronization adjustments;
a Key & Phrase Glossary for consistent translation of specific terms;
coordinating human review using a workflow orchestration system to manage human intervention when necessary;
delivering the final timed text to a designated endpoint, either after AI processing or human review, based on project requirements.

2. The method of claim 1 further comprising the capability of automated decision-making within the workflow orchestration system, which determines the need for human review based on preset rules or client specifications.

3. The method of claim 1 wherein the system integrates Computer Vision tools to identify and translate on-screen text as well as visual cues.

4. The method of claim 1 wherein Generative AI tools are employed to enhance the readability and fluency of the timed text.

5. The method of claim 1 wherein the system is cloud-enabled, allowing scalability across different computing environments.
